(19) United States
(12) Patent Application Publication
(10) Pub. No.: US 2015/0200810 A1
(43) Pub. Date: Jul. 16, 2015

(54) MESSAGE RELIABILITY USING MULTICAST DELIVERY TO MULTIPLE PARENTS

(71) Applicant: CISCO TECHNOLOGY, INC., San Jose, CA (US)

(72) Inventors: Jean-Philippe Vasseur, Saint Martin d'Uriage (FR); Raghuram S. Sudhaakar, Mountain View, CA (US)

(73) Assignee: CISCO TECHNOLOGY, INC., San Jose, CA (US)

(21) Appl. No.: 14/155,856

(22) Filed: Jan. 15, 2014

(51) Int. Cl. H04L 12/24; H04L 12/18

(52) U.S. Cl. CPC H04L 41/0853; H04L 12/1895

(57) ABSTRACT

In one embodiment, a future location of a child node in a network is predicted. One or more potential parent nodes are identified for the child node based on the predicted future location of the child node. The potential parent nodes are then reported to a root node in the network. A first data packet that is multicast to the current parent node and one of the potential parent nodes is received via the current parent node. A second data packet that is also multicast to the current and potential parent nodes is received via the potential parent node.

### TECHNICAL FIELD

The present disclosure relates generally to computer networks, and, more particularly, to multicasting a message to multiple parent nodes in a network.

### BACKGROUND

Low power and Lossy Networks (LLNs), e.g., sensor networks, have a myriad of applications, such as Smart Grid and Smart Cities. Various challenges are presented with LLNs, such as lossy links, low bandwidth, battery operation, low memory and/or processing capability, etc. One example routing solution to LLN challenges is a protocol called Routing Protocol for LLNs or “RPL,” which is a distance vector routing protocol that builds a Destination Oriented Directed Acyclic Graph (DODAG, or simply DAG) in addition to a set of features to bound the control traffic, support local (and slow) repair, etc. The RPL architecture provides a flexible method by which each node performs DODAG discovery, construction, and maintenance.

Challenges remain in applying architectures similar to the RPL architecture to networks that have mobile nodes, such as vehicular networks. In particular, the RPL protocol uses a routing strategy in which all traffic to a particular node is routed via a parent of the node (e.g., a direct or indirect parent, grandparent, great grandparent, etc.). By successively routing to a parent node at each level of the tree, the destination node is eventually found and the packet delivered to the node. However, the constant mobility of nodes in vehicular and other mobile networks often causes the network topology and the parents of a node to change. When a parent change occurs while packets are being routed, at least some of the packets are not delivered to the destination node, resulting in a reduction of the actual application throughput.

### BRIEF DESCRIPTION OF THE DRAWINGS

The embodiments herein may be better understood by referring to the following description in conjunction with the accompanying drawings in which like reference numerals indicate identically or functionally similar elements, of which:

FIG. 1 illustrates an example communication network;

FIG. 2 illustrates an example network device/node;

FIG. 3 illustrates an example message format;

FIG. 4 illustrates an example directed acyclic graph (DAG) in the communication network in FIG. 1;

FIG. 5 illustrates a specific example of a Vehicular Ad Hoc Network (VANET);

FIG. 6 illustrates the physical movement of a DAG node;

FIGS. 7A-7C illustrate examples of potential parent nodes being identified;

FIG. 8 illustrates an example message format having predicted parent node information;

FIG. 9 illustrates another example message format having predicted parent node information;

FIG. 10 illustrates the rearrangement of the DAG of FIG. 4;

FIGS. 11A-11B illustrate examples of multicast packets being sent to a mobile node;

FIGS. 12A-12B illustrate examples of multicast packets sent to a mobile node using a unicast tunnel message;

FIG. 13 illustrates an example simplified procedure for receiving multicasting packets in a mobile network; and

FIG. 14 illustrates an example simplified procedure for multicasting data packets to a network node.

### DESCRIPTION OF EXAMPLE EMBODIMENTS

### Overview

According to one or more embodiments of the disclosure, a future location of a child node in a network is predicted. One or more potential parent nodes are identified for the child node based on the predicted future location of the child node. The potential parent nodes are then reported to a root node in the network. A first data packet that is multicast to the current parent node and one of the potential parent nodes is received via the current parent node. A second data packet that is also multicast to the current and potential parent nodes is received via the potential parent node.

According to one or more additional embodiments of the disclosure, a device receives data indicative of one or more potential parent nodes from a child node in a network, where the one or more potential parent nodes are identified based on the predicted future location of the child node. As such, the device may send a first data packet to a current parent node of the child node and to one of the potential parent nodes, where the first data packet is received by the child node via the current parent node, and sends a second data packet to the current parent node and to one of the potential parent nodes, where the second data packet is received by the child node via the potential parent node.

### DESCRIPTION

A computer network is a geographically distributed collection of nodes interconnected by communication links and segments for transporting data between end nodes, such as personal computers and workstations, or other devices, such as sensors, etc. Many types of networks are available, ranging from local area networks (LANs) to wide area networks (WANs). LANs typically connect the nodes over dedicated private communications links located in the same general physical location, such as a building or campus. WANs, on the other hand, typically connect geographically dispersed nodes over long-distance communications links, such as common carrier telephone lines, optical lightpaths, synchronous optical networks (SONET), synchronous digital hierarchy (SDH) links, or Powerline Communications (PLC) such as IEEE 61334, IEEE P1901.2, and others. In addition, a Mobile Ad-Hoc Network (MANET) is a kind of wireless ad-hoc network, which is generally considered a self-configuring network of mobile routers (and associated hosts) connected by wireless links, the union of which forms an arbitrary topology.

Smart object networks, such as sensor networks, in particular, are a specific type of network having spatially distributed autonomous devices such as sensors, actuators, etc., that cooperatively monitor physical or environmental conditions at different locations, such as, e.g., energy/power consumption, resource consumption (e.g., water/gas/etc. for advanced metering infrastructure or “AMI” applications) temperature, pressure, vibration, sound, radiation, motion, pollutants, etc. Other types of smart objects include actuators, e.g., responsible for turning on/off an engine or perform any other actions. Sensor networks, a type of smart object network, are typically shared-media networks, such as wireless or PLC networks. That is, in addition to one or more sensors, each sensor device (node) in a sensor network may generally be equipped with a radio transceiver or other communication port such as PLC, a microcontroller, and an energy source, such as a battery. Often, smart object networks are considered field area networks (FANs), neighborhood area networks (NANs), etc. Generally, size and cost constraints on smart object nodes (e.g., sensors) result in corresponding constraints on resources such as energy, memory, computational speed and bandwidth.

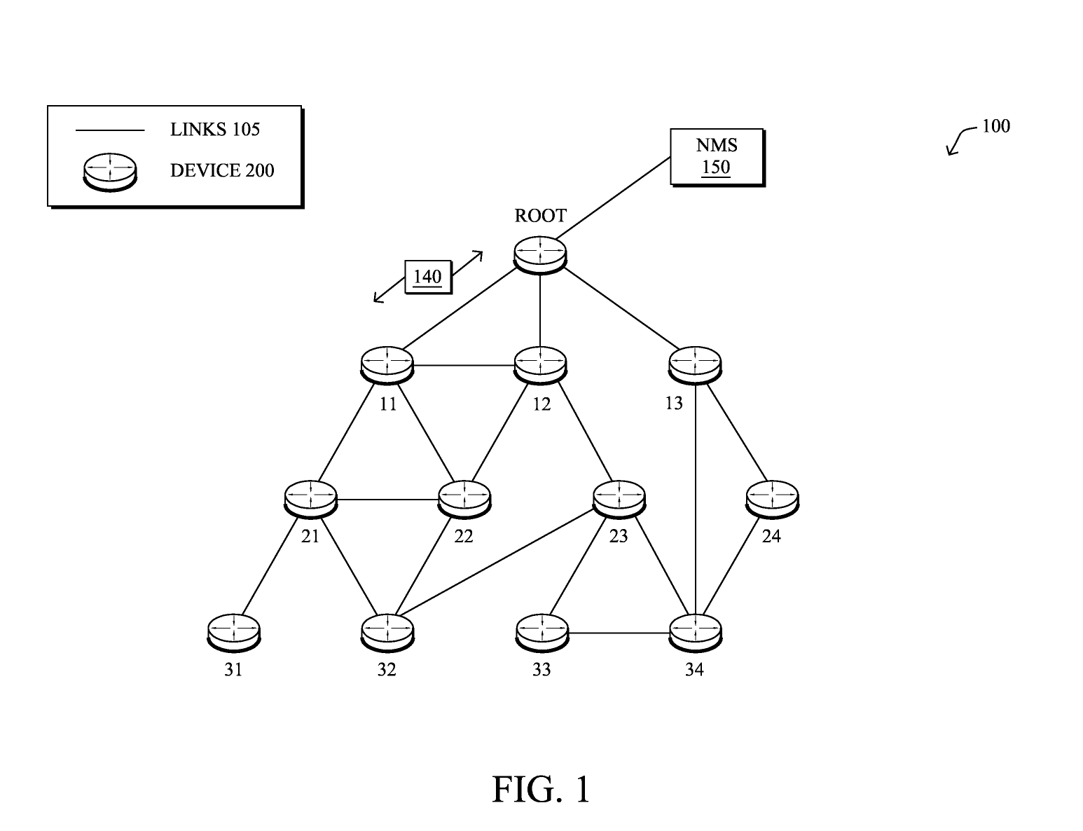

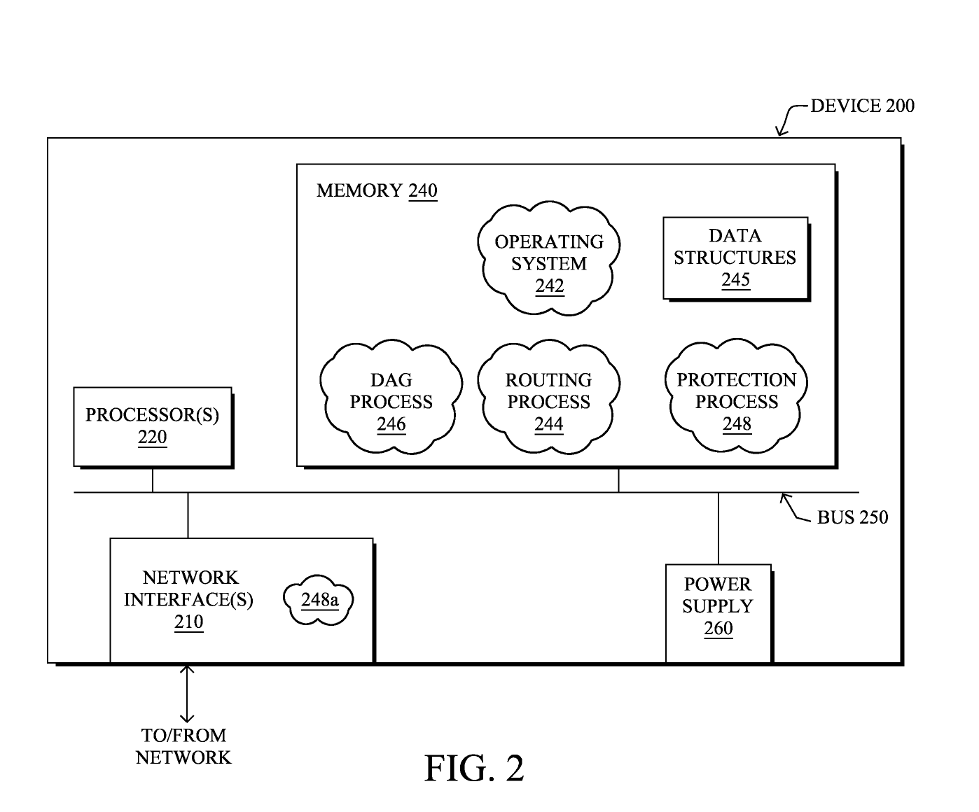

FIG. 1 is a schematic block diagram of an example computer network 100 illustratively comprising nodes/devices 200 (e.g., labeled as shown, “ROOT,” “11,” “12,” . . . “34,” and described in FIG. 2 below) interconnected by various methods of communication. For instance, the links 105 may generally be shared-media (e.g., wireless links), where certain nodes 200, such as, e.g., routers, sensors, computers, etc., may be in communication with other nodes 200, e.g., based on distance, signal strength, current operational status, location, etc. In addition, a network management device, such as a network management server (NMS) 150, may also be in communication with the network 100, such as via a WAN or backhaul link to the root node. Those skilled in the art will understand that any number of nodes, devices, links, etc. may be used in the computer network, and that the view shown herein is for simplicity. Also, those skilled in the art will further understand that while the network is shown in a certain orientation, particularly with a “root” border router node, the network 100 is merely an example illustration that is not meant to limit the disclosure.

Data packets 140 (e.g., traffic and/or messages sent between the devices/nodes) may be exchanged among the nodes/devices of the computer network 100 using predefined network communication protocols such as certain known wireless protocols (e.g., IEEE Std. 802.11, IEEE Std. 802.15.4, WiFi, Bluetooth®, etc.), or other protocols where appropriate. In this context, a protocol consists of a set of rules defining how the nodes interact with each other.

FIG. 2 is a schematic block diagram of an example node/device 200 that may be used with one or more embodiments described herein, e.g., as any of the nodes shown in FIG. 1 above. The device may comprise one or more network interfaces 210 (e.g., wireless), at least one processor 220, and a memory 240 interconnected by a system bus 250, as well as a power supply 260 (e.g., battery, plug-in, etc.).

The network interface(s) 210 contain the mechanical, electrical, and signaling circuitry for communicating data over links 105 coupled to the network 100. The network interfaces may be configured to transmit and/or receive data using a variety of different communication protocols. Note, further, that certain nodes may have two different types of network connections 210, e.g., wireless and wired/physical connections, and that the view herein is merely for illustration. For example, while some devices 200 may be entirely mobile (e.g., cars), other devices 200 may represent unmoving devices, and may allow for a wired connection, accordingly.

The memory 240 comprises a plurality of storage locations that are addressable by the processor 220 and the network interfaces 210 for storing software programs and data structures associated with the embodiments described herein. Note that certain devices may have limited memory or no memory (e.g., no memory for storage other than for programs/processes operating on the device and associated caches). The processor 220 may comprise necessary elements or logic adapted to execute the software programs and manipulate the data structures 245. An operating system 242, portions of which are typically resident in memory 240 and executed by the processor, functionally organizes the device by, inter alia, invoking operations in support of software processes and/or services executing on the device. These software processes and/or services may comprise routing process/services 244 and a directed acyclic graph (DAG) process 246, as well as an illustrative process 248, as described herein. Note that while process 248 is shown in centralized memory 240, one or more embodiments specifically provide for the process, or particular portions of the “process,” to be specifically operated within the network interfaces 210, e.g., as part of a MAC or PHY layer (process “248a”).

It will be apparent to those skilled in the art that other processor and memory types, including various computer-readable media, may be used to store and execute program instructions pertaining to the techniques described herein. Also, while the description illustrates various processes, it is expressly contemplated that various processes may be embodied as modules configured to operate in accordance with the techniques herein (e.g., according to the functionality of a similar process). Further, while the processes have been shown separately, those skilled in the art will appreciate that processes may be routines or modules within other processes.

Routing process (services) 244, where used in a routing environment, contains computer executable instructions executed by the processor 220 to perform functions provided by one or more routing protocols, such as proactive or reactive routing protocols as will be understood by those skilled in the art. These functions may, on capable devices, be configured to manage a routing/forwarding table (a data structure 245) containing, e.g., data used to make routing/forwarding decisions. In particular, in proactive routing, connectivity is discovered and known prior to computing routes to any destination in the network, e.g., link state routing such as Open Shortest Path First (OSPF), or Intermediate-System-to-Intermediate-System (ISIS), or Optimized Link State Routing (OLSR). Reactive routing, on the other hand, discovers neighbors (i.e., does not have an a priori knowledge of network topology), and in response to a needed route to a destination, sends a route request into the network to determine which neighboring node may be used to reach the desired destination. Example reactive routing protocols may comprise Ad-hoc On-demand Distance Vector (AODV), Dynamic Source Routing (DSR), DYnamic MANET On-demand Routing (DYMO), etc. Notably, on devices not capable or configured to store routing entries, routing process 244 may consist solely of providing mechanisms necessary for source routing techniques. That is, for source routing, other devices in the network can tell the less capable devices exactly where to send the packets, and the less capable devices simply forward the packets as directed.

Notably, mesh networks have become increasingly popular and practical in recent years. In particular, shared-media mesh networks, such as wireless or PLC networks, etc., are often on what is referred to as Low-Power and Lossy Networks (LLNs), which are a class of network in which both the routers and their interconnect are constrained: LLN routers typically operate with constraints, e.g., processing power, memory, and/or energy (battery), and their interconnects are characterized by, illustratively, high loss rates, low data rates, and/or instability. LLNs are comprised of anything from a few dozen and up to thousands or even millions of LLN routers, and support point-to-point traffic (between devices inside the LLN), point-to-multipoint traffic (from a central control point such at the root node to a subset of devices inside the LLN) and multipoint-to-point traffic (from devices inside the LLN towards a central control point).

An example implementation of LLNs is an “Internet of Things” network. Loosely, the term “Internet of Things” or “IoT” may be used by those in the art to refer to uniquely identifiable objects (things) and their virtual representations in a network-based architecture. In particular, the next frontier in the evolution of the Internet is the ability to connect more than just computers and communications devices, but rather the ability to connect “objects” in general, such as lights, appliances, vehicles, HVAC (heating, ventilating, and air-conditioning), windows and window shades and blinds, doors, locks, etc. The “Internet of Things” thus generally refers to the interconnection of objects (e.g., smart objects), such as sensors and actuators, over a computer network (e.g., IP), which may be the Public Internet or a private network. Such devices have been used in the industry for decades, usually in the form of non-IP or proprietary protocols that are connected to IP networks by way of protocol translation gateways. With the emergence of a myriad of applications, such as the smart grid, smart cities, and building and industrial automation, and cars (e.g., that can interconnect millions of objects for sensing things like power quality, tire pressure, and temperature and that can actuate engines and lights), it has been of the utmost importance to extend the IP protocol suite for these networks.

An example protocol specified in an Internet Engineering Task Force (IETF) Internet Draft, entitled “RPL: IPv6 Routing Protocol for Low Power and Lossy Networks”<RFC6550> by Winter, at al. (Mar. 13, 2011 version), provides a mechanism that supports multipoint-to-point (MP2P) traffic from devices inside the LLN towards a central control point (e.g., LLN Border Routers (LBRs) or “root nodes/devices” generally), as well as point-to-multipoint (P2MP) traffic from the central control point to the devices inside the LLN (and also point-to-point, or “P2P” traffic). RPL (pronounced “ripple”) may generally be described as a distance vector routing protocol that builds a Directed Acyclic Graph (DAG) for use in routing traffic/packets 140, in addition to defining a set of features to bound the control traffic, support repair, etc. Notably, as may be appreciated by those skilled in the art, RPL also supports the concept of Multi-Topology-Routing (MTR), whereby multiple DAGs can be built to carry traffic according to individual requirements.

A DAG is a directed graph having the property that all edges (and/or vertices) are oriented in such a way that no cycles (loops) are supposed to exist. All edges are contained in paths oriented toward and terminating at one or more root nodes (e.g., “clusterheads or “sinks”), often to interconnect the devices of the DAG with a larger infrastructure, such as the Internet, a wide area network, or other domain. In addition, a Destination Oriented DAG (DODAG) is a DAG rooted at a single destination, i.e., at a single DAG root with no outgoing edges. A “parent” of a particular node within a DAG is an immediate successor of the particular node on a path towards the DAG root, such that the parent has a lower “rank” than the particular node itself, where the rank of a node identifies the node's position with respect to a DAG root (e.g., the farther away a node is from a root, the higher is the rank of that node). Further, in certain embodiments, a sibling of a node within a DAG may be defined as any neighboring node which is located at the same rank within a DAG. Note that siblings do not necessarily share a common parent, and routes between siblings are generally not part of a DAG since there is no forward progress (their rank is the same). Note also that a tree is a kind of DAG, where each device/node in the DAG generally has one parent or one preferred parent.

DAGs may generally be built (e.g., by DAG process 246) based on an Objective Function (OF). The role of the Objective Function is generally to specify rules on how to build the DAG (e.g. number of parents, backup parents, etc.).

In addition, one or more metrics/constraints may be advertised by the routing protocol to optimize the DAG against. Also, the routing protocol allows for including an optional set of constraints to compute a constrained path, such as if a link or a node does not satisfy a required constraint, it is “pruned” from the candidate list when computing the best path. (Alternatively, the constraints and metrics may be separated from the OF.) Additionally, the routing protocol may include a “goal” that defines a host or set of hosts, such as a host serving as a data collection point, or a gateway providing connectivity to an external infrastructure, where a DAG's primary objective is to have the devices within the DAG be able to reach the goal. In the case where a node is unable to comply with an objective function or does not understand or support the advertised metric, it may be configured to join a DAG as a leaf node. As used herein, the various metrics, constraints, policies, etc., are considered “DAG parameters.”

Illustratively, example metrics used to select paths (e.g., preferred parents) may comprise cost, delay, latency, bandwidth, expected transmission count (ETX), etc., while example constraints that may be placed on the route selection may comprise various reliability thresholds, restrictions on battery operation, multipath diversity, bandwidth requirements, transmission types (e.g., wired, wireless, etc.). The OF may provide rules defining the load balancing requirements, such as a number of selected parents (e.g., single parent trees or multi-parent DAGs). Notably, an example for how routing metrics and constraints may be obtained may be found in an IETF Internet Draft, entitled “Routing Metrics used for Path Calculation in Low Power and Lossy Networks” <RFC6651> by Vasseur, et al. (Mar. 1, 2011 version). Further, an example OF (e.g., a default OF) may be found in an IETF Internet Draft, entitled “RPL Objective Function 0” <RFC6552> by Thubert (Jul. 8, 2011 version) and “The Minimum Rank Objective Function with Hysteresis”<RFC6719> by O. Gnawali et al. (May 17, 2011 version).

Building a DAG may utilize a discovery mechanism to build a logical representation of the network, and route dissemination to establish state within the network so that routers know how to forward packets toward their ultimate destination. Note that a “router” refers to a device that can forward as well as generate traffic, while a “host” refers to a device that can generate but does not forward traffic. Also, a “leaf” may be used to generally describe a non-router that is connected to a DAG by one or more routers, but cannot itself forward traffic received on the DAG to another router on the DAG. Control messages may be transmitted among the devices within the network for discovery and route dissemination when building a DAG.

According to the illustrative RPL protocol, a DODAG Information Object (DIO) is a type of DAG discovery message that carries information that allows a node to discover a RPL Instance, learn its configuration parameters, select a DODAG parent set, and maintain the upward routing topology. In addition, a Destination Advertisement Object (DAO) is a type of DAG discovery reply message that conveys destination information upwards along the DODAG so that a DODAG root (and other intermediate nodes) can provision downward routes. A DAO message includes prefix information to identify destinations, a capability to record routes in support of source routing, and information to determine the freshness of a particular advertisement. Notably, “upward” or “up” paths are routes that lead in the direction from leaf nodes towards DAG roots, e.g., following the orientation of the edges within the DAG. Conversely, “downward” or “down” paths are routes that lead in the direction from DAG roots towards leaf nodes, e.g., generally going in the opposite direction to the upward messages within the DAG.

Generally, a DAG discovery request (e.g., DIO) message is transmitted from the root device(s) of the DAG downward toward the leaves, informing each successive receiving device how to reach the root device (that is, from where the request is received is generally the direction of the root). Accordingly, a DAG is created in the upward direction toward the root device. The DAG discovery reply (e.g., DAO) may then be returned from the leaves to the root device(s) (unless unnecessary, such as for UP flows only), informing each successive receiving device in the other direction how to reach the leaves for downward routes. Nodes that are capable of maintaining routing state may aggregate routes from DAO messages that they receive before transmitting a DAO message. Nodes that are not capable of maintaining routing state, however, may attach a next-hop parent address. The DAO message is then sent directly to the DODAG root that can in turn build the topology and locally compute downward routes to all nodes in the DODAG. Such nodes are then reachable using source routing techniques over regions of the DAG that are incapable of storing downward routing state. In addition, RPL also specifies a message called the DIS (DODAG Information Solicitation) message that is sent under specific circumstances so as to discover DAG neighbors and join a DAG or restore connectivity.

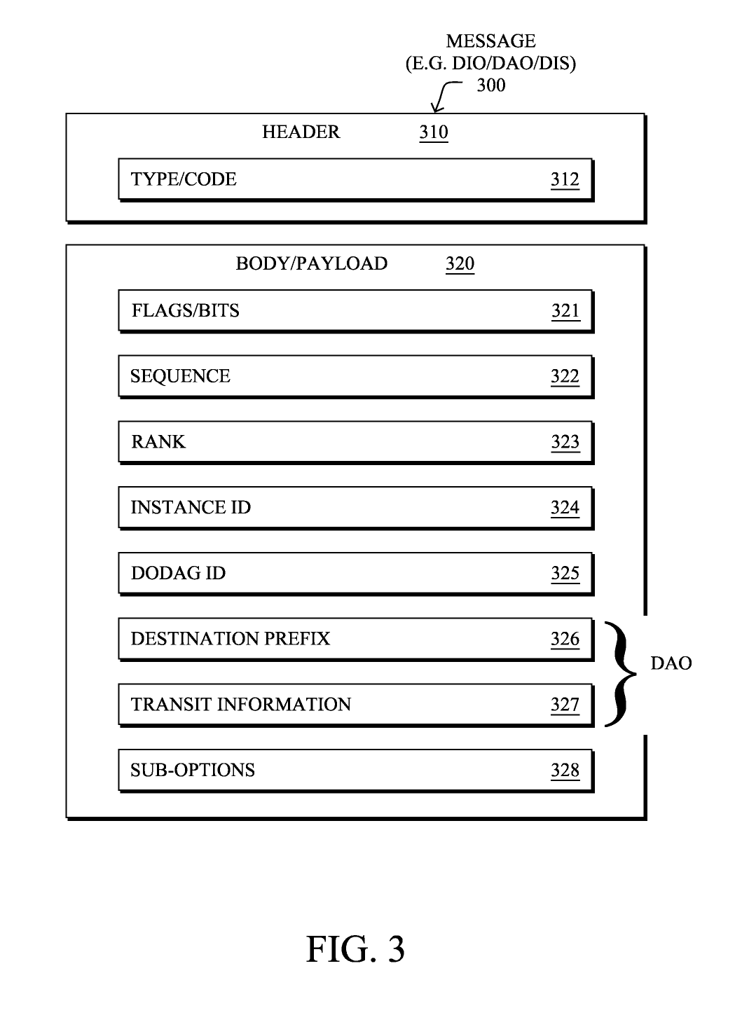

FIG. 3 illustrates an example simplified control message format 300 that may be used for discovery and route dissemination when building a DAG, e.g., as a DIO, DAO, or DIS message. Message 300 illustratively comprises a header 310 with one or more fields 312 that identify the type of message (e.g., a RPL control message), and a specific code indicating the specific type of message, e.g., a DIO, DAO, or DIS. Within the body/payload 320 of the message may be a plurality of fields used to relay the pertinent information. In particular, the fields may comprise various flags/bits 321, a sequence number 322, a rank value 323, an instance ID 324, a DODAG ID 325, and other fields, each as may be appreciated in more detail by those skilled in the art. Further, for DAO messages, additional fields for destination prefixes 326 and a transit information field 327 may also be included, among others (e.g., DAO_Sequence used for ACKs, etc.). For any type of message 300, one or more additional sub-option fields 328 may be used to supply additional or custom information within the message 300. For instance, an objective code point (OCP) sub-option field may be used within a DIO to carry codes specifying a particular objective function (OF) to be used for building the associated DAG. Alternatively, sub-option fields 328 may be used to carry other certain information within a message 300, such as indications, requests, capabilities, lists, notifications, etc., as may be described herein, e.g., in one or more type-length-value (TLV) fields.

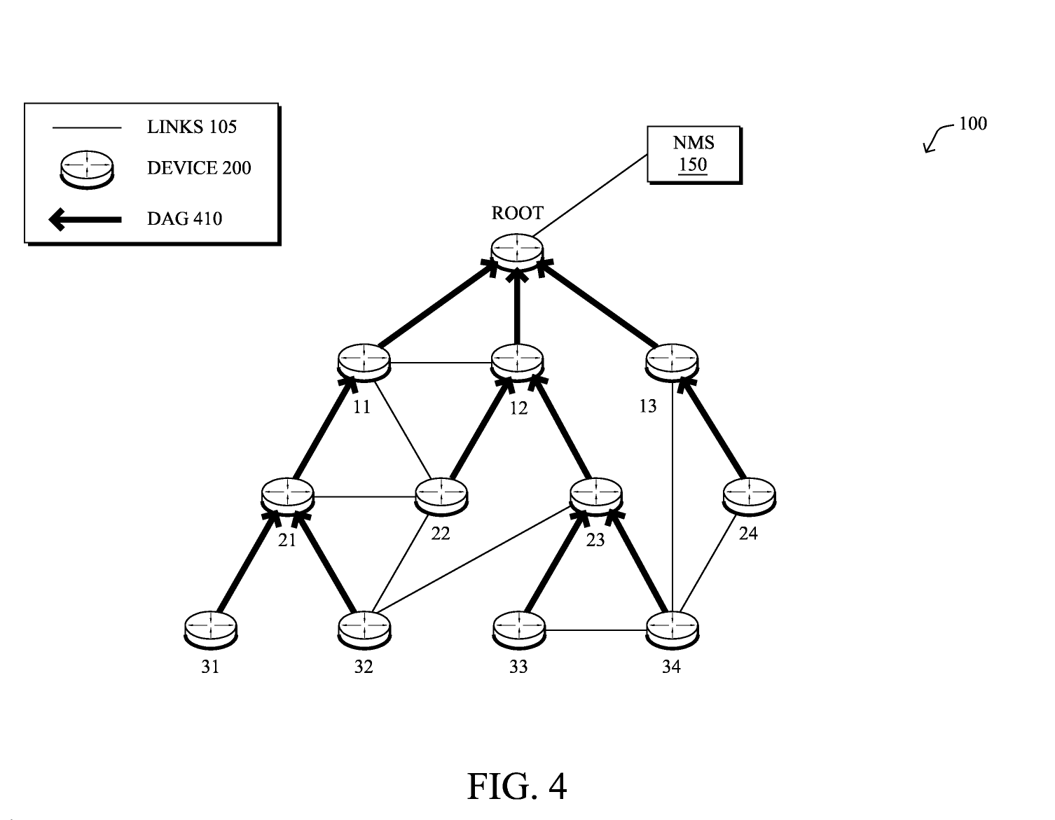

FIG. 4 illustrates an example simplified DAG that may be created, e.g., through the techniques described above, within network 100 of FIG. 1. For instance, certain links 105 may be selected for each node to communicate with a particular parent (and thus, in the reverse, to communicate with a child, if one exists). These selected links form the DAG 410 (shown as solid bolded lines), which extends from the root node toward one or more leaf nodes (nodes without children). Traffic/packets 140 (shown in FIG. 1) may then traverse the DAG 410 in either the upward direction toward the root or downward toward the leaf nodes, particularly as described herein. In addition, the creation of the DAG may also provide for one or more alternate parents (next-hops). Note that while a DAG 410 is shown, other distance vector routing topologies may be created, and a DAG, particularly one created using RPL, is merely one example of a routing protocol topology that may be created and utilized according to the techniques described herein.

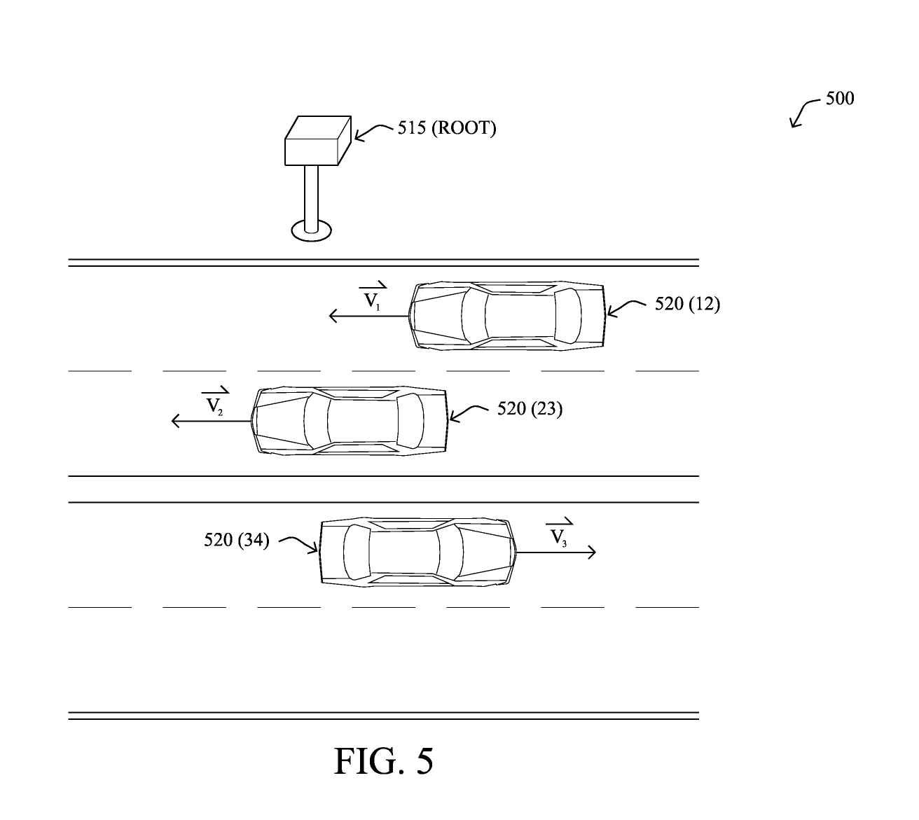

As an example, FIG. 5 illustrates a simplified VANET scenario 500 (with node references from the topology in FIG. 1), where a plurality of vehicles (cars, trucks, etc.) 520 may be in proximity to one another, while traveling at different speeds and directions (i.e., along vectors v₁-v₃). Also, one or more road side units (RSUs) 515 may also be present along the side of the roadway, whether placed specifically for the purpose of vehicular communication (e.g., highways), or else another roadside unit configuration, such as a WiFi hotspot in the city.

Note that as free WiFi networks become predictably more accessible from vehicles, users will have a strong economic incentive to opportunistically offload data traffic from 3G and 4G links to free WiFi links. Since WiFi deployment is not prevalent, enabling vehicles to access roadside WiFi through other vehicles (multihop-to-infrastructure) allow more vehicles to take advantage of data offloading. From the perspective of the service providers, enabling vehicles to use a multihop-to-infrastructure architecture reduces the number of WiFi access points they need to deploy, thereby reducing the capital cost of WiFi infrastructure rollout. Moreover, as more vehicles are connected in the future, the network will inevitably support applications beyond safety to infotainment, video streaming, online gaming, etc. These applications tend to carry high volume data traffic, making ad hoc 802.11 type of wireless communication a suitable strategy. Thus, enabling multihop-to-infrastructure connectivity generally requires the support of a multihop-to-infrastructure vehicular routing protocol.

The concepts and routing strategy used by RPL are finding some use in mobile scenarios, such as in vehicular networks. In particular, RPL has been found to be efficient at providing connectivity to a group of vehicular nodes that need to connect to an infrastructure node (e.g., via a RSU) to access a larger intranet or the Internet in general. In this case, the infrastructure node acts as the root of the tree/DAG and the vehicular nodes form the branches and leaves of the tree.

However, RPL is a tree based routing protocol that was originally designed for static sensor networks. One of the core aspects of RPL lies in the use of an objective function (OF) configured on the DAG Root that determines the rules that control how nodes join the DAG. The OF specifies the list of metrics and constraints used to build the DAG in addition to a number of rules and objectives. For example, one objective may be to find the shortest path based on a reliability metric (i.e., the most reliable path), while avoiding battery operated nodes. Such an OF would typically be used in a smart metering application. Another example objective used for substation automation and control would be to find the shortest path based on a delay metric (i.e., the shortest delay) while using encrypted links. The RPL architecture provides a flexible method by which each node performs DODAG discovery, construction, and maintenance by having each node construct and maintain the DODAG edges.

As noted above, challenges remain in applying the RPL architecture to mobile networks, such as vehicular networks. In particular, the RPL protocol uses a routing strategy in which all traffic to a particular node is routed via a parent of the node (e.g., a direct or indirect parent, grandparent, great grandparent, etc.). By successively routing to a parent of the node at each level of the tree, the node is eventually found and the packet delivered to the node. However, the constant mobility of nodes in vehicular and other mobile networks often causes the network topology and the parents of a node to change. When a parent change occurs while packets are being routed, the packet is not delivered to the node, resulting in a loss of the actual application throughput. This situation is fairly common in vehicular networks and will result in the overall performance of the network being very low in terms of actual application throughput or “goodput” (i.e., traffic that reaches its destination).

Multicasting Packets in a Mobile Network

The techniques herein provide for mechanisms whereby packets are preemptively routed to a predicted future parent in a mobile network of a destination node so that the number of packets lost by the application is minimized. In one aspect, techniques are presented in which a node conveys information regarding its predicted future parent(s) to its current parent(s) and to the network root. In another aspect, an objective function may be used to optimize the tradeoff between goodput and the network load. In particular, when using RPL in a vehicular network or other mobile network, there is a high probability for packets to be lost when a node changes parents due to mobility and the overall dynamics of the DAG. According to the techniques described herein, each node may predict its future parents and periodically informs the root node, to improve the overall application throughput of the network. When forwarding packets to a node in the RPL DAG (e.g., from the Internet, etc.), the root node multicasts the packet to one or more of the predicted parents of the node. Thus, application throughput of the node is dramatically improved, and the reliability to effectively deliver the packet to the mobile node on the return path. The tradeoff in this case is the increased network load. Such a solution significantly contrasts with existing approaches by introducing a probabilistic routing paradigm that also uses proactive routing.

Specifically, according to one or more embodiments of the disclosure as described in detail below, a future location of a child node in a network is predicted. One or more potential parent nodes are identified for the child node based on the predicted future location of the child node. The potential parent nodes are then reported to a root node in the network. A first data packet that is multicast to the current parent node and one of the potential parent nodes is received via the current parent node. A second data packet that is also multicast to the current and potential parent nodes is received via the potential parent node.

Illustratively, the techniques described herein may be performed by hardware, software, and/or firmware, such as in accordance with the process 248/248a, which may contain computer executable instructions executed by the processor 220 (or independent processor of interfaces 210) to perform functions relating to the techniques described herein, e.g., in conjunction with routing process 244 (and/or DAG process 246). For example, the techniques herein may be treated as extensions to conventional protocols, such as the illustrative RPL protocol and/or wireless communication protocols, and as such, may be processed by similar components understood in the art that execute those protocols, accordingly.

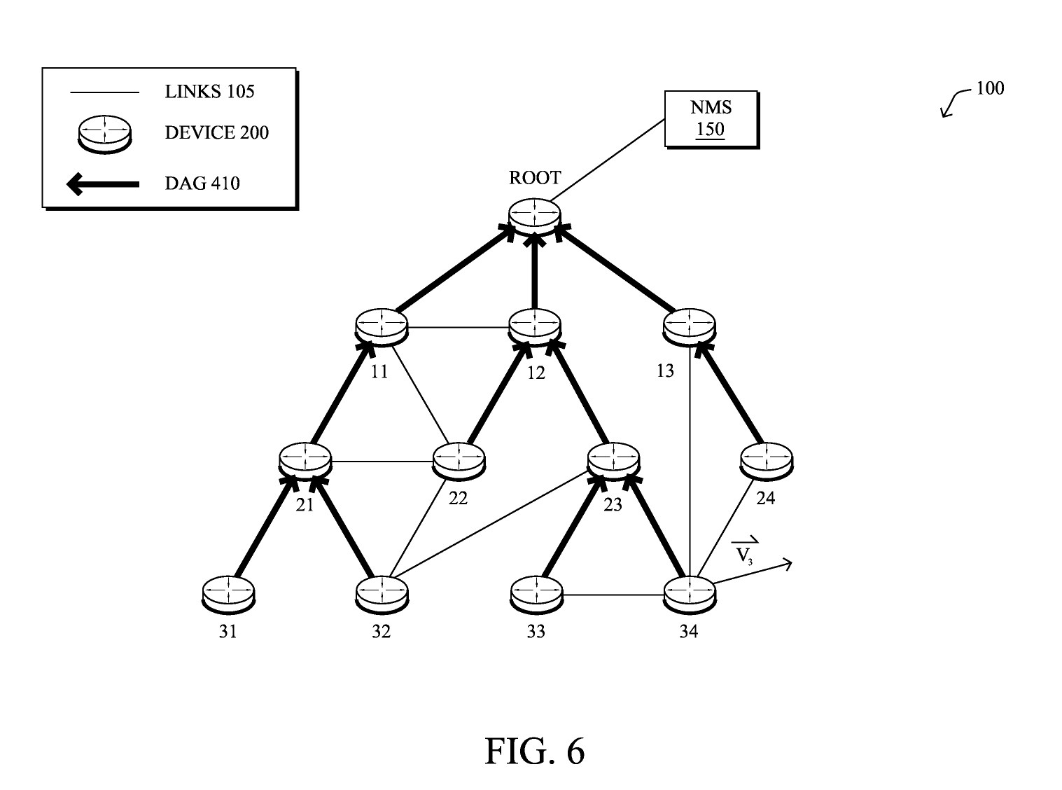

Operationally, a mechanism is first herein defined whereby a vector of parameters is used to estimate the mobility of a network node/device and predict a future location of the node. As shown in FIG. 6, for example, assume that network node/device 34 is moving along a vector v₃. According to various embodiments, node 34 or another node in network 100 is configured to predict a future location of node 34. The predicted future location may be based in part on the current location of node 34. For example, node 34 may utilize global positioning service (GPS) data, triangulation data, or the like to determine the current location of node 34. The predicted future location of node 34 may also be based in part on motion data representing the motion of node 34. For example, node 34 may use velocity data, acceleration data (e.g., from an accelerometer), or a history of locations to determine the direction of travel of node 34. In some cases, the future location of node 34 may be predicted based in part on map data (e.g., to predict a future location is not a point along motion vector v₃).

Further, according to one or more embodiments herein, a child node in the network identifies one or more potential parent nodes that could be used by the child node in the future. In RPL, for example, a node maintains a table of candidate parents. In a sufficiently dense network, such as a vehicular network, a node is able to hear DIO messages from different parents. All of these parents are listed in the candidate parent list maintained by the child node. The current parent is chosen based on parameters like link quality, link stability etc. According to the techniques described herein, each node may use a probabilistic model that includes the mobility vectors and current location of the nodes in combination with a map of the region to identify one or more potential parent nodes.

In some embodiments, a device/node may select up to a threshold number of potential parent nodes based on various factors, such as the current location of the node(s), directional vectors associated with the node(s), link quality metrics, link stability metrics, or other such factors. For example, each node may identify candidate parents based on their current locations and direction vectors that are advertises in the DIO packets. Typically, the best parent would be one that is moving in the same direction as the child node since the stability of the link will be the highest. However, other potential parents moving in different directions may also be selected depending on the circumstances. There is also no need for each node to have a map that shows the position of every other node and in fact, this would be infeasible in many situations. In other words, a node/device may combine information regarding its predicted future location with a calculated link quality to each node in its preferred parent set and to its current parent. Based on these parameters, the child node chooses up to a threshold number of potential parents (e.g., up to four parents or any other number of parents) with which the child node is most likely to establish a parent-child relationship within a fixed amount of time.

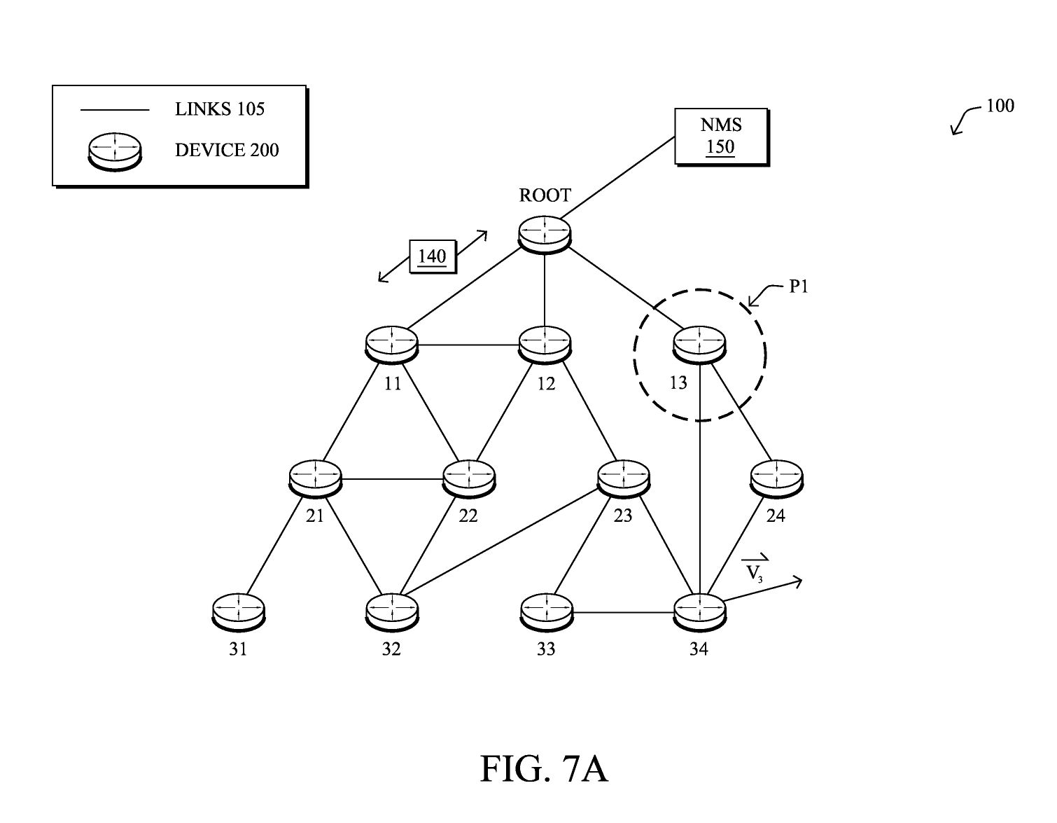

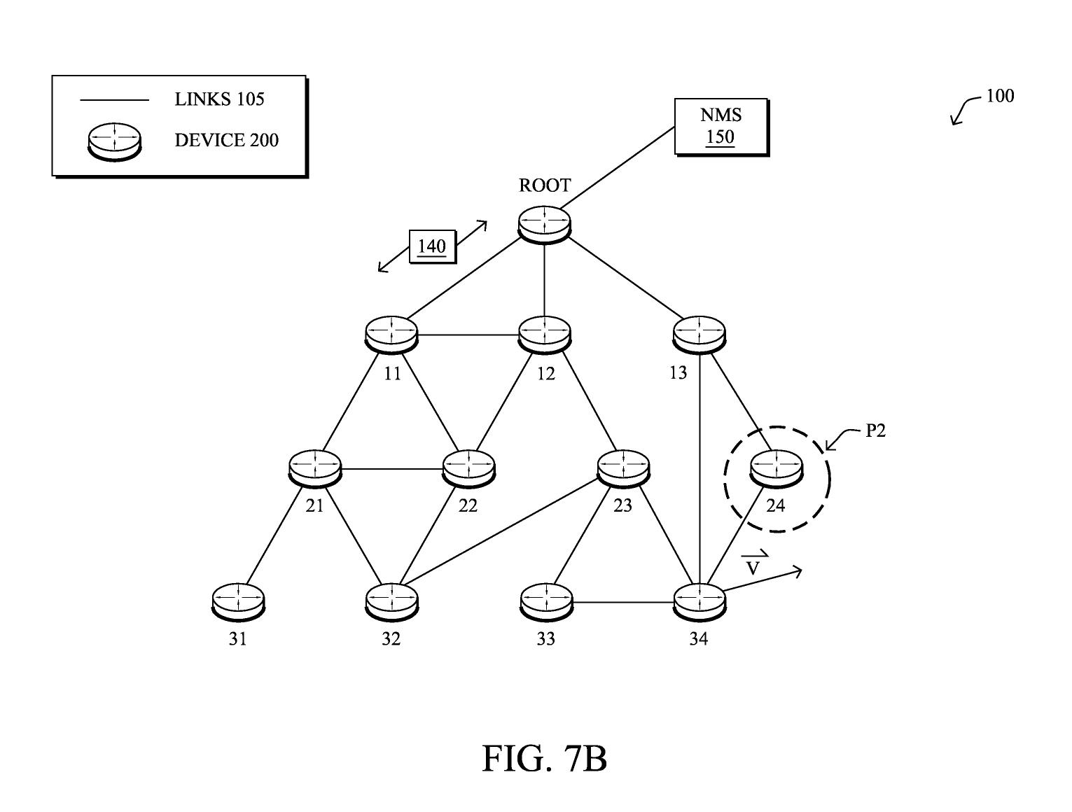

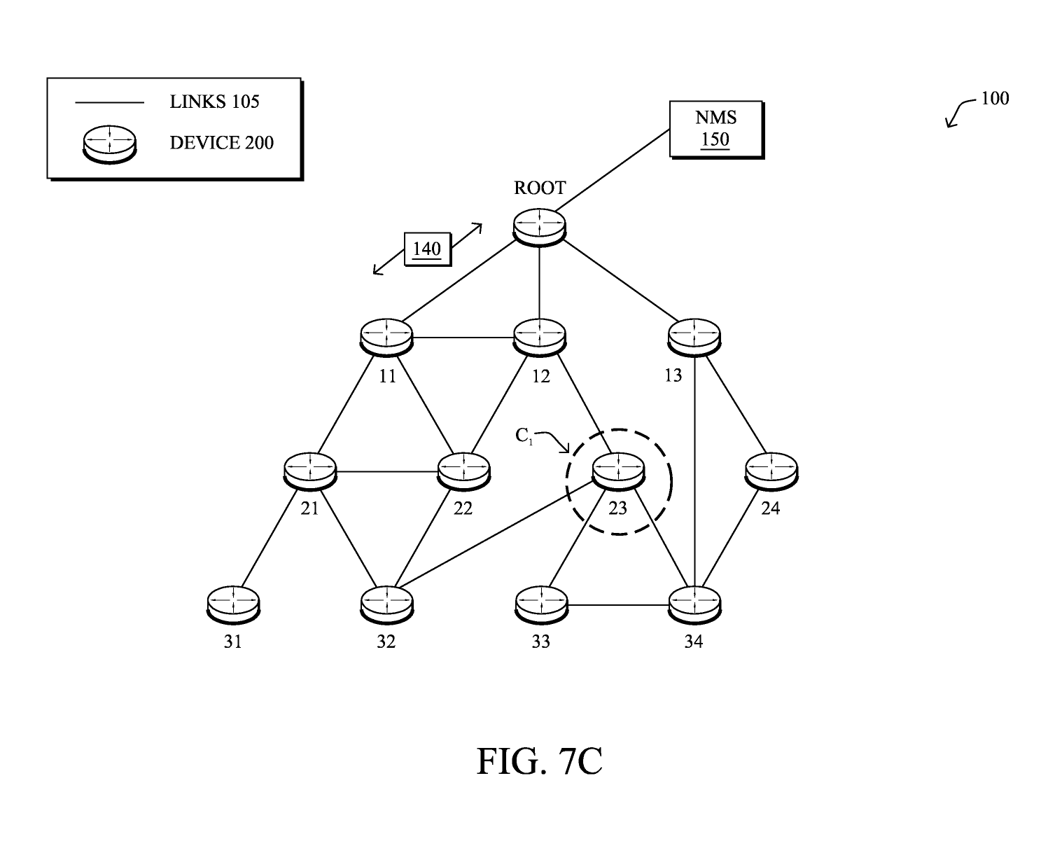

FIGS. 7A-7C illustrate examples of the identification of potential parent nodes in the communication network of FIG. 1 by child node/device 34. As shown, node 34 may receive DIO messages from nodes 13, 23, 24, 33, or any other additional nodes. Such messages may indicate link quality metrics, link stability metrics, and/or location and motion information regarding nodes 13, 23, 24, 34, etc. Node 34 may maintain the received information a parent table by node 34 in accordance with the RPL protocol or another such routing protocol. According to the teachings herein, node 34 may further select the n-number “best” candidates from among nodes 13, 23, 24, 34, etc. to represent the set of potential future parents of node 34.

As shown in FIGS. 7A-7B, node 34 may identify node 13 as a first potential parent node and node 24 as a second potential parent node, based on the current location of node 34, the predicted future location of node 34, and the information received from nodes 13 and 24 (e.g., link metrics, the directions of travel of the nodes, etc.). Node 34 may identify up to a threshold number of potential parent nodes. For example, if network 100 has a high density of nodes, node 34 may select the four best parent candidates from among twenty nodes. In FIG. 7C, node 34 may also identify node 23 as its current parent and evaluate node 23 for inclusion as a potential future node within a set time interval.

Each node in the network may update the root when there is change to the set of predicted parents for the node and/or to the order of the predicted parents. In typical vehicular networks, the vehicles tend to move in clusters and the rate of change of the predicted parents will be pretty slow, meaning that the additional network traffic due to the predicted parent updates will typically be minimal. However, a tradeoff may be made between the efficiency of the mechanism and the rate of updates that each node provides by tuning the rate of updates to avoid flooding of the network with control traffic.

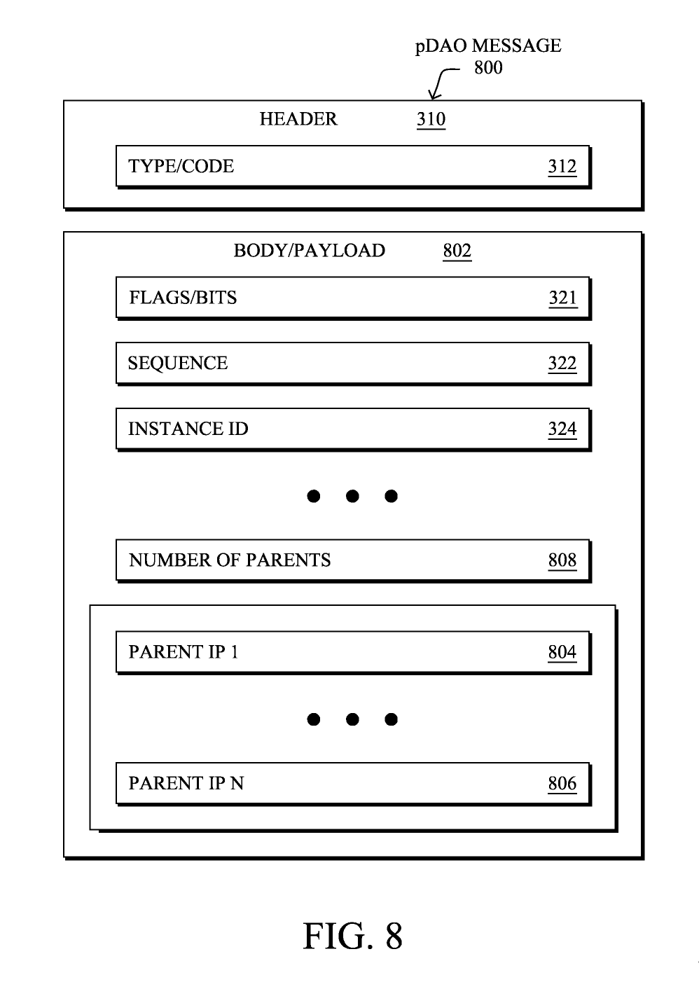

According to one or more embodiments herein, a node/device may generate and send a predictive DAO (pDAO) message that identifies its potential future parents to the root. In FIG. 8, a simplified example pDAO message format 800 is shown that includes potential parent node information. As shown, pDAO message 800 may include any or all of the RPL standard data shown in message 300 in FIG. 3. For example, pDAO may include a type/code field 312 in a header 310. Standard DAO fields may also be included within body/payload 802, such as an RPL Instance ID in field 324, a DAO Sequence ID in field 322, and flags/bits 321 (e.g., a K flag that specifies whether the sending node expects an acknowledgement back, a D flag that specifies whether a DODAG ID field is present, etc.). In addition, pDAO message 800 may include a field 808 that indicates the number of potential parents that were identified and selected by the sending node (e.g., the number of parent fields that will follow the first four bytes of message 800). Message 800 may further include fields 804-806 that indicate the n-number of potential parent nodes identified by the sending device (e.g., as IP addresses or other node identifiers), as specified by field 808. For example, fields 804-806 may indicate the top four “best” potential future parent candidates determined by the sending node.

Once generated and sent by the child node, pDAO message 800 may traverse the current DAG to reach the root node of the network. In response, the root node registers the predicted parents in its routing table for the node that sent pDAO message 800 (e.g., with a */32 entry). The root node may then use the received parent information to transmit packets to the child node, e.g., as part of a multicast methodology that increases the likelihood of reception by the child node.

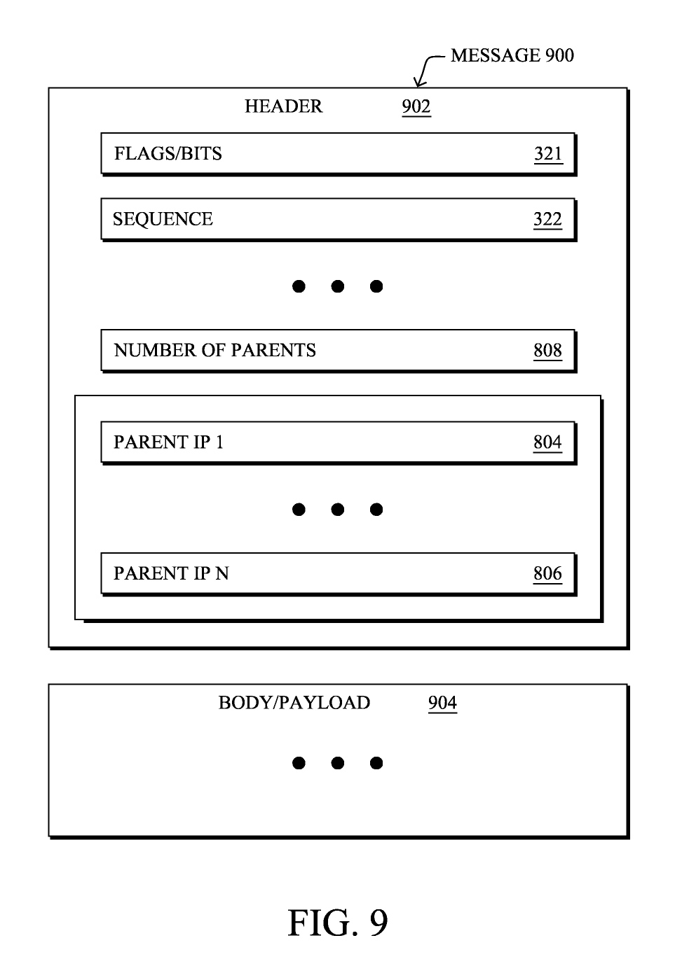

According to various embodiments, a pDAO packet can alternatively be piggybacked as a custom header on data packets that can be removed by the RPL DAG root. For example, as shown in FIG. 9, the fields of pDAO message 800 may be encapsulated in the header of a message 900. Such an encapsulation may be performed within an IPv6 hop-by-hop header or other customizable header. In response to receiving message 900, the root may strip out and process the pDAO information contained in header 902 in addition to processing body/payload 904. For example, the root may strip out the IP addresses contained in field 804-806 from message 900 and use the potential parent nodes to rout data to the child node.

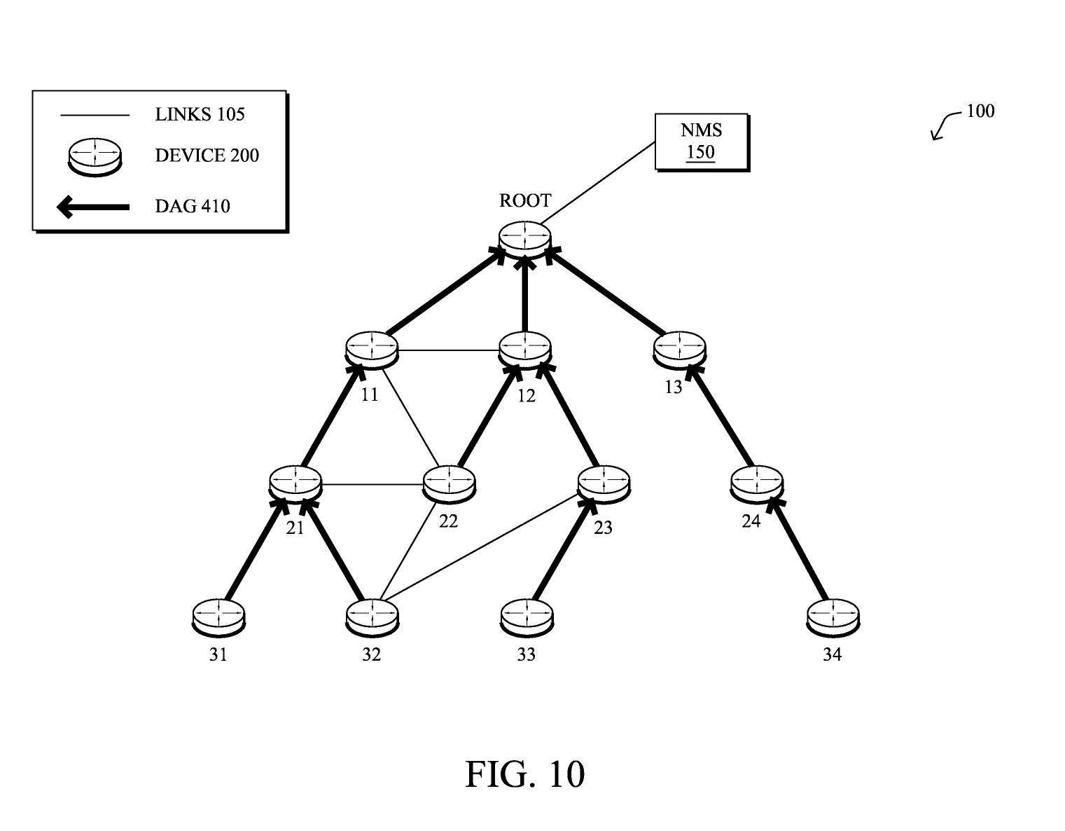

As noted above, a root node may use the potential parent information received from a node in the network to multicast a packet to the node. In other words, when receiving packets destined for the child node endpoint, the root node multicasts it to one or more potential parent nodes of the endpoint, to account for the possibility that the node has moved from one parent to another during the interval in which the request and response data packets are sent. For example, as shown in FIG. 10, the movement of node 34 may be such that a new DAG 1000 is formed at some point in the future in which the current parent of node 34 switches from being node 23 to being node 24. However, as noted previously, the topology of the network may be dynamic and may change during the transmission of data from the root to a destination network node, prior to the root receiving any information about the change.

In some embodiments, a root may only multicast packets to a destination node for which it cannot accurately predict the correct branch. In other words, the root may utilize a threshold parameter based on the link qualities, node movements, etc., to determine whether or not to multicast a data packet to a destination node. This parameter can be tuned to minimize the amount of redundant packets being sent. However, sending at least a small amount of redundant packets will improve the overall throughput that can be achieved by the destination node.

The techniques disclosed herein differ from existing techniques that use multiple parents to minimize the delay and improve the probability in delivering packets from a node to a root. In particular, previous techniques have focused on an optimization problem under the assumption that all traffic will flow from the node to the root. This is useful for sensor networks wherein the nodes are data sources and all data needs to be sent to a gateway (typically the root). However, these approaches do not sufficiently address this situation in which RPL is applied to a mobile network, such a vehicle network. Prior implementations have also formulated the optimization problem on the assumption that the underlying MAC layer is 802.15.4 TSCH. Using the techniques herein, no such limitation exists. For example, the present techniques support an underlying MAC layer such as 802.11n, to support the higher throughput requirements of the application space, which consequently leads to very different mechanisms.

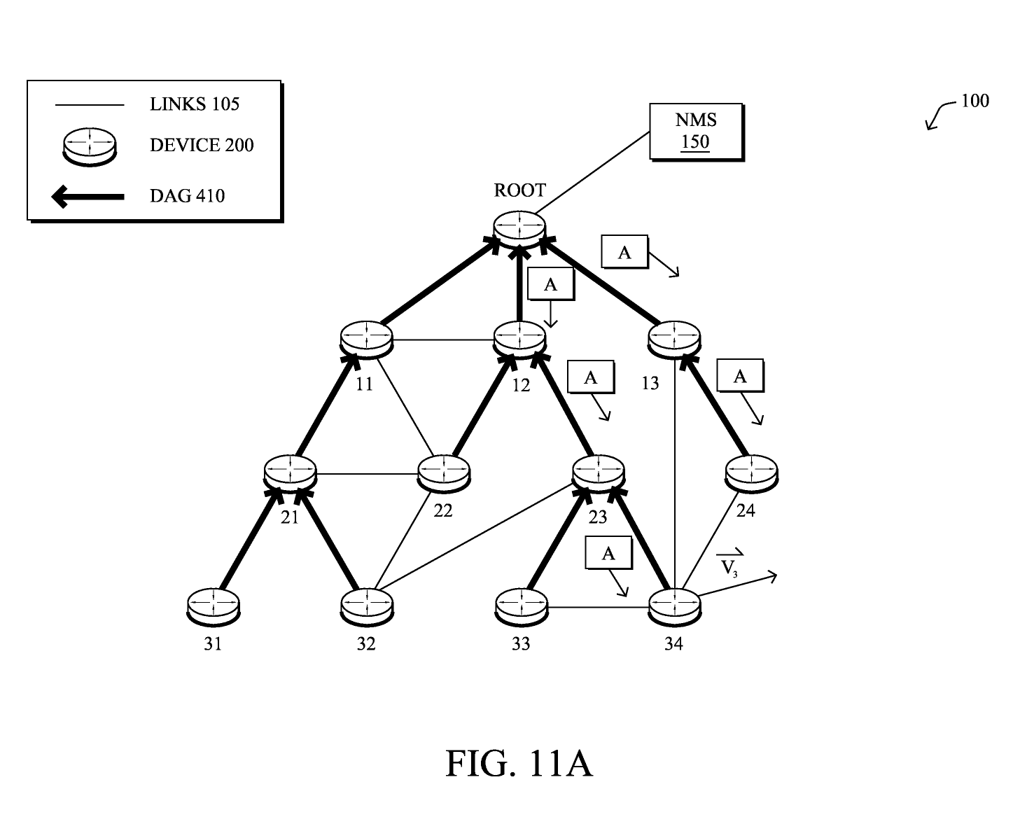

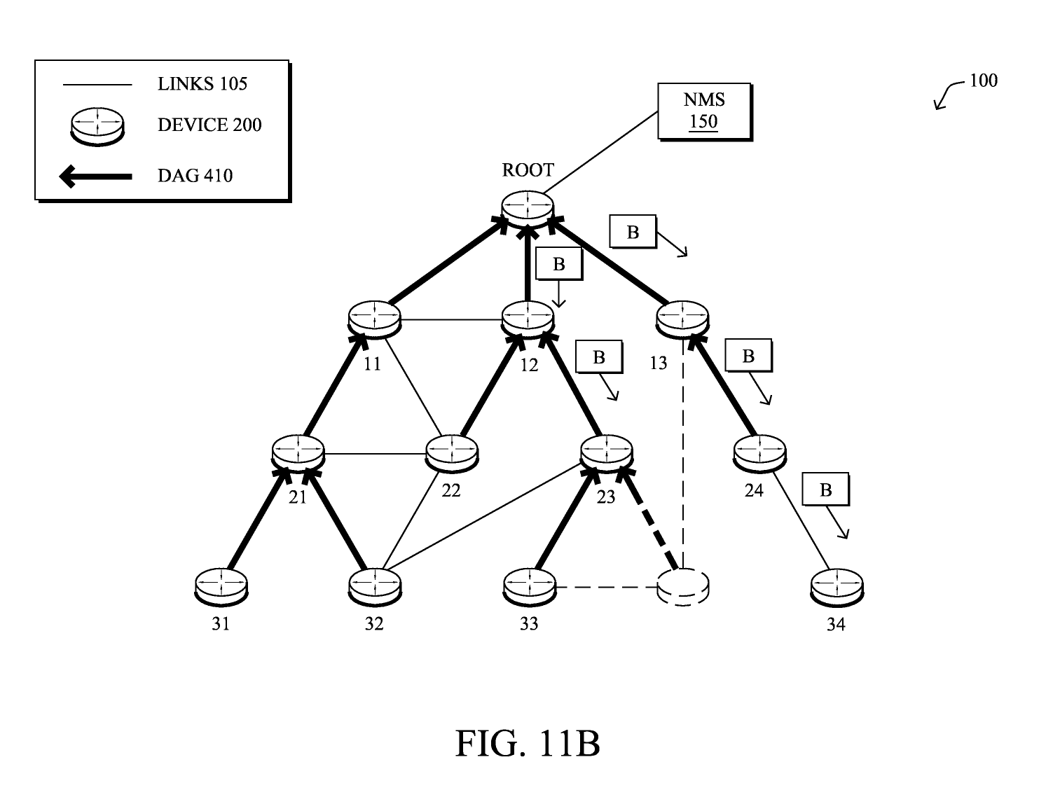

As shown in FIGS. 11A-11B, the root node of network 100 may multicast data packets to the current parent of node 34 and one or more predicted parent nodes along different network paths. In FIG. 11A, the root may multicast a first data packet A down separate branches of network 100 to node 23 (i.e., the current parent of node 34) and to node 24 (i.e., a predicted parent of node 34), at a first point in time. At this time, node 34 is able to receive the data packet via its current parent node 23 due to the relative locations of the nodes. In FIG. 11B, the root may follow the same approach at a second point in time to multicast a second data packet B to nodes 23 and 24. However, due to the motion of the destination node 34, node 23 may no longer be a parent node of node 34 because the link between the two nodes either no longer exists or has greatly reduced performance. While node 23 is no longer a parent of node 34, it is still considered the “current parent” from the perspective of the root, since the root does not have actual knowledge of the change. In contrast to node 23, potential parent node 24 and node 34 are located relative to one another at the second point in time such that node 24 is still able to deliver the second data packet B. Thus, even though the network has changed such that node 23 is no longer the parent of node 34, the data packets sent by the root are still received by node 34.

In one illustrative example of network operation, consider the situation in which node 34 sends a request for an Internet video via the root network node. In response, data may begin streaming from the server to the root, which determines the network path to reach the destination node 34. In a static network, this choice may be made using the network links that were previously discovered. In a mobile network, however, there is no such guarantee that node 34 will not move from one branch to another while the video traffic is being sent to it along the RPL tree. If the first few megabytes of the video data are sent over the current branch (e.g., via nodes 12, 23) and the next few megabytes are sent over the predicted branch (e.g., via nodes 13, 24), the effective throughput of the network can be increased by minimizing the packet loss to node 34. If this is not done and all video data is sent only to the branch containing node 23, the data will be discarded by node 23 when the destination node 34 moves and changes parents. Thus, the techniques herein allow a root node to decide how to partition and forward large streams of data based using feedback on the mobility of the network nodes.

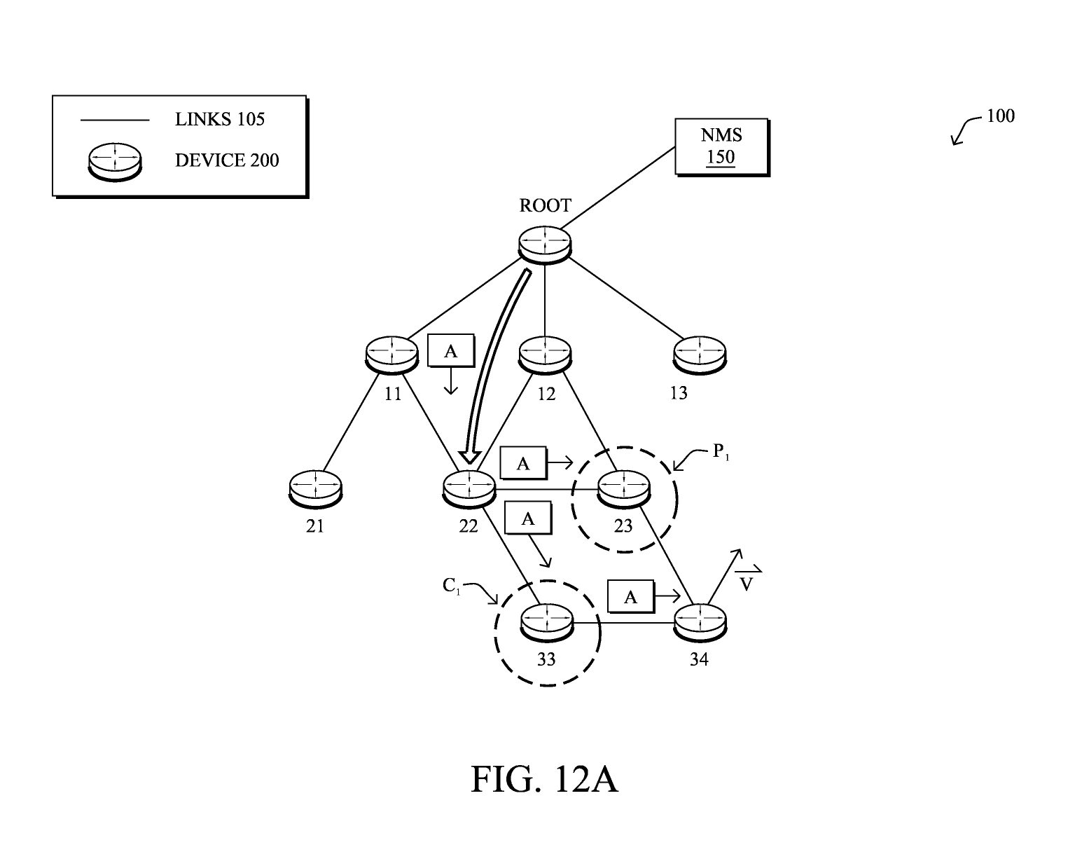

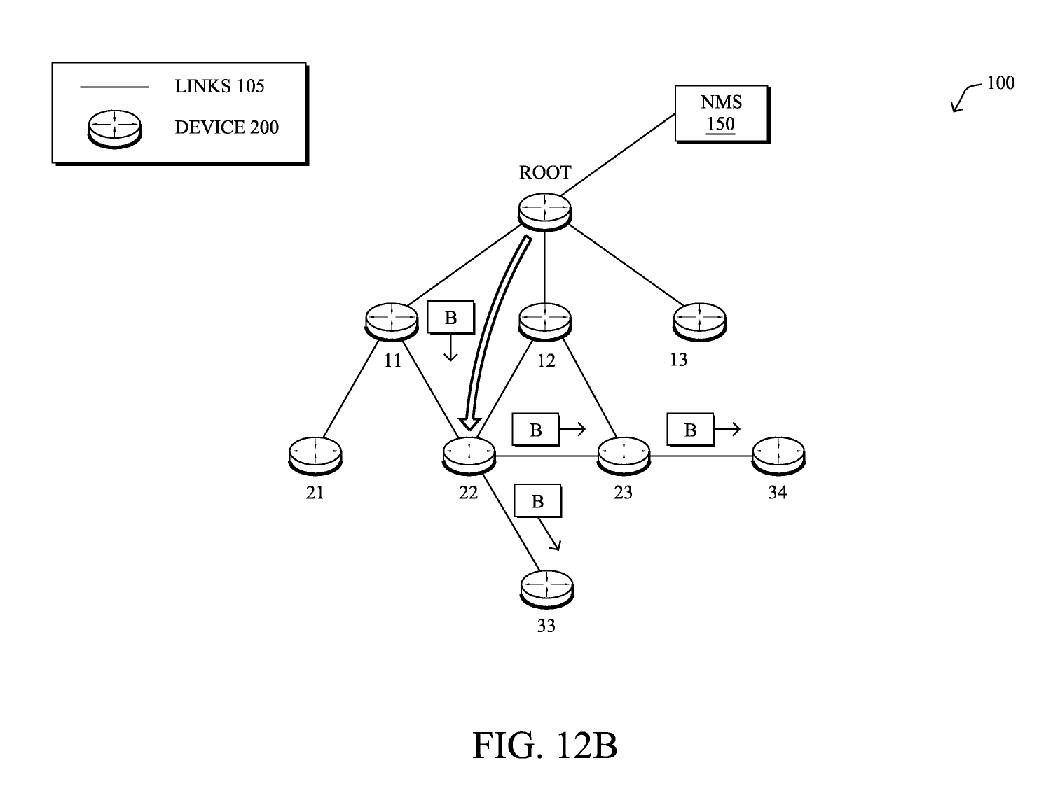

As shown in FIGS. 12A-12B, packets may be multicast to the destination node 34 by encapsulating the multicast packets from the root in a unicast sent to a common ancestor node, if such a node exists, according to various embodiments. For example, as shown in FIG. 12A, destination node 34 may have a current parent node 33 and a predicted parent node 23. Both of nodes 23 and 33 may share a common ancestor node 22. In such a case, the root may send data packet A to node 22 as a tunneled, unicast message. On receipt of the unicast message, ancestor node 22 multicasts data packet A to both nodes 23 and 33. Accordingly, destination node 34 may receive data packet A via its current parent node 33. In FIG. 12B, this process may be repeated for a second data packet B at another point in time. However, due to the motion of destination node 34, node 33 is no longer the parent of node 34. In such a case, destination node 34 still receives data packet B via node 23, which was previously identified as a potential parent node based on the motion of node 34.

The percentage of improvement to the goodput of the network can also be optimized using an objective function (OF). Such an approach may be used to find the right balance between the number of copies of data packets that are being sent to different parents and the level of reliability that is expected. In one embodiment, the global OF will include a function Fₐ, of network load (X) and reliability (Y) in addition to the optimization function F. Such an OF may be of the form:

OF=F+Fa(aX+bY)

In other words, the routing mechanism may attempt to globally ensure that the network satisfies an expected load, degree of reliability, and satisfy any other network objectives (e.g., as represented by function F). In another embodiment each node can send a different optimization parameter, to achieve highly granular performance in the network. This extra parameter can be sent as part of a pDAO packet by appending a representation of the function Fa to the packet. The root node can then determine how many copies of the packet to send and whether to send a copy to all predicted parents.

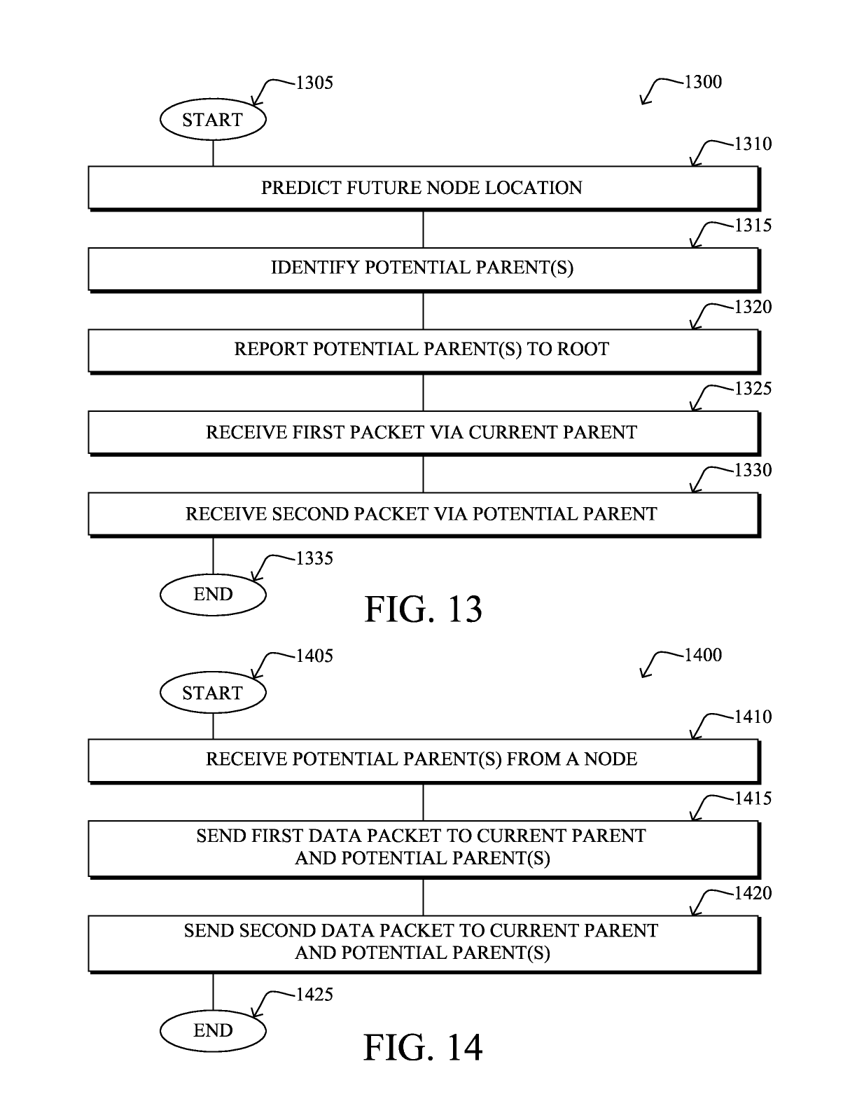

FIG. 13 illustrates an example simplified procedure for receiving multicasting packets in a mobile network in accordance with one or more embodiments described herein (e.g., from the perspective of a child device/node). The procedure 1300 may start at step 1305, and continue on to step 1310, where, as described in greater detail above, a future location of a network node is predicted. Procedure 1300 continues on to step 1315 where, based on the predicted future location of the node, one or more potential future parents of the node are identified. In step 1320, the one or more potential future parents are reported to the root of the network. At step 1325, a first data packet is received via the current parent of the node. Procedure 1300 then continues on to step 1330 where a second data packet is received by the node via one of the identified potential parents and ends at step 1335. In various embodiments, both the first and second data packets are multicast to the receiving node via both its current parent and its potential parent.

FIG. 14 illustrates an example simplified procedure for multicasting data packets to a network node (e.g., by a network root device/node), in accordance with one or more embodiment described herein. Procedure 1400 starts at step 1405 and continues on to step 1410 in which data indicative of one or more potential parents is received from a network node. In step 1415, a first data packet is sent to both the current parent of the network node and to one or more of the potential parents. In step 1420, a second data packet is also sent to both the current parent of the network node and to the one or more potential parents. As highlighted in greater detail above, steps 1415 and 1420 may be performed by multicasting the first and second data packets directly from the root or by sending the packets as a tunneled unicast message to a common ancestor node of the destination node that, in turn, multicasts the packets. Procedure 1400 then ends at step 1425.

It should be noted that while certain steps within procedures 1300-1400 may be optional as described above, the steps shown in FIGS. 13-14 are merely examples for illustration, and certain other steps may be included or excluded as desired. Further, while a particular order of the steps is shown, this ordering is merely illustrative, and any suitable arrangement of the steps may be utilized without departing from the scope of the embodiments herein. Moreover, while procedures 1300-1400 are described separately, certain steps from each procedure may be incorporated into each other procedure, and the procedures are not meant to be mutually exclusive.

The techniques described herein, therefore, provide for considerable improvements to a mobile network's application throughput. Since application throughput directly affects a user's perception of the network service, it may be important that the application throughput is maintained above a certain threshold. The techniques described herein are also backwards compatible with existing networks. For example, a network that contains nodes implementing these techniques can coexist with nodes that do not implement this feature. In other words, it is only mandatory that the root node implements the disclosed methodologies. The techniques herein further integrate seamlessly with the existing OFs and do not require any additional overhead to convey the goodput versus network tradeoff to the root node.

While there have been shown and described illustrative embodiments that provide for dynamic enabling of routing devices in a shared-media communication network, it is to be understood that various other adaptations and modifications may be made within the spirit and scope of the embodiments herein. For example, the embodiments herein have been shown and described primarily with regard to vehicle networks. However, the embodiments in their broader sense are not as limited, and may, in fact, be used with other types of mobile networks in which at least some of the nodes are in motion. In addition, while certain protocols are shown, such as RPL, other suitable protocols may be used, accordingly.

The foregoing description has been directed to specific embodiments. It will be apparent, however, that other variations and modifications may be made to the described embodiments, with the attainment of some or all of their advantages. For instance, it is expressly contemplated that the components and/or elements described herein can be implemented as software being stored on a tangible (non-transitory) computer-readable medium (e.g., disks/CDs/RAM/EEPROM/etc.) having program instructions executing on a computer, hardware, firmware, or a combination thereof. Accordingly this description is to be taken only by way of example and not to otherwise limit the scope of the embodiments herein. Therefore, it is the object of the appended claims to cover all such variations and modifications as come within the true spirit and scope of the embodiments herein.

What is claimed is:

1. A method, comprising:
predicting a future location of a child node in a network;
identifying one or more potential parent nodes for the child node based on the predicted future location of the child node;
reporting the potential parent nodes to a root node in the network;
receiving a first data packet from the root via a current parent node; and
receiving a second data packet from one of the potential parent nodes, wherein the first and second data packets are multicast to the current parent node and to the potential parent node.

2. The method as in claim 1, wherein the first and second data packets are unicast from the root to a common ancestor node and multicast from the common ancestor node to the current and potential parent nodes.

3. The method as in claim 1, wherein the first and second data packets are multicast from the root to the current and potential parent nodes.

4. The method as in claim 1, wherein the potential parent nodes are reported in response to a detected change in the potential parent nodes.

5. The method as in claim 1, further comprising:
reporting an optimization parameter to the root node comprising a level of network performance.

6. The method as in claim 1, wherein reporting the potential parent nodes to the root node comprises:
including the potential parent nodes in a destination advertisement object (DAO) message.

7. The method as in claim 1, wherein reporting the potential parent nodes to the root node comprises:
including the potential parent nodes in a custom header of data packets sent to the root node.

8. The method as in claim 1, wherein the first and second data packets are multicast to a second potential parent node based on a global network objective function.

9. The method as in claim 1, wherein the predicted future location is predicted based on data selected from a group comprising: global positioning system (GPS) data, velocity data, and accelerometer data.

10. An apparatus, comprising:
one or more network interfaces to communicate with a network;
a processor coupled to the network interfaces and configured to execute one or more processes; and
a memory configured to store a process executable by the processor, the process when executed operable to:
predict a future location of a child node in a network;
identify one or more potential parent nodes for the child node based on the predicted future location of the child node;
report the potential parent nodes to a root node in the network;
receive a first data packet from the root via a current parent node; and
receive a second data packet from one of the potential parent nodes, wherein the first and second data packets are multicast to the current parent node and to the potential parent node.

11. The apparatus as in claim 10, wherein the first and second data packets are unicast from the root to a common ancestor node and multicast from the common ancestor node to the current and potential parent nodes.

12. The apparatus as in claim 10, wherein the first and second data packets are multicast from the root to the current and potential parent nodes.

13. The apparatus as in claim 10, wherein the potential parent nodes are reported in response to a detected change in the potential parent nodes.

14. The apparatus as in claim 10, wherein the potential parent nodes are reported to the root node by including the potential parent nodes in a destination advertisement object (DAO) message.

15. A method, comprising:
receiving data indicative of one or more potential parent nodes from a child node in a network, wherein the one or more potential parent nodes are identified based on the predicted future location of the child node;
sending a first data packet to a current parent node of the child node and to one of the potential parent nodes, wherein the first data packet is received by the child node via the current parent node;
sending a second data packet to the current parent node and to one of the potential parent nodes, wherein the second data packet is received by the child node via the potential parent node.

16. The method as in claim 15, further comprising:
multicasting the first and second data packets to the current parent node and to the potential parent node.

17. The method as in claim 15, further comprising:
identifying a common ancestor node of the current parent node and the potential parent node; and
sending the first and second data packets as tunneled unicast messages to the common ancestor node, wherein the common ancestor node multicasts the first and second data packets to the current and potential parent nodes.

18. The method as in claim 15, further comprising:
selecting a number of the potential parent nodes to receive the first and second data packets based on a network objective function; and
sending the first and second data packets to the selected number of potential parent nodes.

19. An apparatus, comprising:
one or more network interfaces to communicate with a network;
a processor coupled to the network interfaces and configured to execute one or more processes; and
a memory configured to store a process executable by the processor, the process when executed operable to:
receive data indicative of one or more potential parent nodes from a child node in a network, wherein the one or more potential parent nodes are identified based on the predicted future location of the child node;
send a first data packet to a current parent node of the child node and to one of the potential parent nodes, wherein the first data packet is received by the child node via the current parent node;
send a second data packet to the current parent node and to one of the potential parent nodes, wherein the second data packet is received by the child node via the potential parent node.

20. The apparatus as in claim 19, wherein the process when executed is operable to:
multicast the first and second data packets to the current parent node and to the potential parent node.
